(19) United States
(12) Patent Application Publication
(10) Pub. No.: US 2026/0189900 A1
(43) Pub. Date: Jul. 2, 2026

(54) SECURED PRIVATE COMMUNICATION NETWORK

(71) Applicant: ORANGE, Issy-les-Moulineaux (FR)

(72) Inventor: Olivier LEPETIT, Chatillon (FR)

(21) Appl. No.: 18/858,124

(22) PCT Filed: Apr. 18, 2023
(86) PCT No.: PCT/EP2023/059983

§ 371 Date: Nov. 20, 2024

(30) Foreign Application Priority Data
Apr. 20, 2022 (FR) FR2203613

(51) Int. Cl. H04W 12/02; H04W 4/80; H04W 12/06; H04W 12/50; H04W 76/10

(52) U.S. Cl. CPC H04W 12/02; H04W 4/80; H04W 12/068; H04W 12/50; H04W 76/10

(57) ABSTRACT

A method and a device for pairing a terminal provided with a near-field communication module over a private network having an access point provided with a near-field communication module. The access point is located in the immediate vicinity of a user, the access point being able to communicate with the terminal: over a first near-field communication channel using the electromagnetic wave conduction capacities of the user's body; and: over a second channel that is separate from the first channel. The method includes, at the access point: obtaining a connection request message over the first channel when the user performs a motion to enter the immediate vicinity of the terminal; transmitting a connection message including a network password; and pairing the terminal over the private network.

### 1. FIELD OF THE INVENTION

The invention relates to the establishment of a private communication network using near-field technology.

### 2. PRIOR ART

The invention particularly relates to a terminal accessing a wireless network, for example, a Wi-Fi network, administered by an access point, for example, a home gateway or a “mobile hotspot” type mobile telephone where a mobile telephone is used as a network gateway. Currently, in order to connect to the access point, the user enters the identification parameters of the local area network, for example, of the Wi-Fi type, into the terminal. In particular, using a preliminary process called “pairing”, which is well known to a person skilled in the art, they enter or select the name of the home network, such as an SSID (“Service Set Identifier”), which is often in the form of an alphanumeric string (for example: “MOB666”) and, in most cases, a key, or password, for accessing the home network, such as a WEP (“Wired Equivalent Privacy”) or WPA (“Wi-Fi Protected Access”) or PSK (“Pre-Shared Key”) key. The users of the terminals must at least enter the network password. Such inputting is often tedious, especially since it is difficult to generate an easy to memorize password and still have a certain level of security, in other words, that guarantees the strength of the password that is used, i.e., makes it less vulnerable to attacks from hackers aimed at appropriating it.

Therefore, the prior art needs to be improved.

### 3. DISCLOSURE OF THE INVENTION

The invention improves the prior art. To this end, it relates to a method for pairing a terminal provided with a near-field module over a private network having an access point provided with a near-field module, with said access point being located in the immediate vicinity of a user, said access point being able to communicate with the terminal:
over a first near-field channel using the electromagnetic wave conduction capabilities of the body of said user; and
over a second channel separate from the first channel, the method comprising, at the access point positioned in the vicinity of the user, the following steps of:
obtaining a request message for connecting over the first channel, when said user performs a movement to enter the immediate vicinity of the terminal;
transmitting a connection message comprising a password for said network;
pairing the terminal over said private network.

The invention thus allows a private network, for example, of the hotspot type, to be created by allowing pairing of the terminals in relation to which the user is positioned in a near-field.

Advantageously, the method uses the electromagnetic wave conduction capabilities of the human body. This data transmission channel is also known as IBC “Intra Body Communication”. When the user touches the terminal, a radio carrier wave, or electromagnetic signal, is transmitted by the terminal through the body of the user to the access point, which is positioned in the vicinity of the user and is adapted to receive such a signal. If the access point is a smartphone type mobile device, the IBC allows data to be received on the mobile device of the user via their body, while allowing the user to keep their device in their pocket, for example. If the access point is a gateway-type device, the IBC allows data to be received over the gateway via the body of the user simply by approaching or touching it.

Once the terminal has the password and has transmitted it to the access point, conventional pairing can be carried out for connecting the terminal and the access point and linking it to the private network administered by the access point.

“IBC” or IBC communication is understood to mean a near-field communication passing through the body of the user, compatible with a conventional NFC communication, in which the terminal that comprises the NFC device is in the physical vicinity of its NFC counterpart. Unlike the body transmission systems that use electrodes, the use of IBC dispenses with electrodes by using conventional NFC-type chips and by being based on NFC standards. In addition, NFC/IBC does not require physical contact with the user, but only proximity (of the order of a few centimeters) between the body of the user and the terminal or the access point.

“Access point” is understood herein to mean any routing element able to create a local area network, for example, a Wi-Fi network: gateway, mobile terminal set up as a hotspot, router, etc., and having an NFC module adapted to receive the IBC signals, hereafter called NFC/IBC module.

“Terminal” is understood to mean a terminal provided with an NFC/IBC module. It can be a mobile telephone, a tablet, a connected object, etc., for example.

“Near-field communication module” or “NFC/IBC module” is understood to mean a controller, or NFC (CLF “ContactLess Frontend”) component forming a near-field communication module like an electromagnetic transponder and comprising software components (firmware, etc.) required for implementing NFC communications. Such a component is associated with an antenna, which transmits the received NF signals to the NFC component.

“Private network” is understood herein to mean a local type of network, for example, a Wi-Fi network, which allows terminals to dialogue with one another and optionally with a broadband network, for example, the Internet, via an access point. This private network may or may not overlap the local or company network conventionally administered by the access point. Indeed, some access points (for example, a service gateway) can create and manage several networks, for example, a first network (said private network) for the sensitive data of the user, a guest network for temporary connections, a local area network for the peripherals of the home/company, etc.

According to another functional aspect, the invention also relates to a method for requesting pairing of a terminal provided with a near-field module over a private network having an access point provided with a near-field module, with said access point being located in the immediate vicinity of a user, said access point being able to communicate with the terminal:
over a first near-field channel using the electromagnetic wave conduction capabilities of the body of said user; and
over a second channel separate from the first channel, the method comprising, at the terminal, the following steps of:
transmitting a message over the first channel requesting connection when said user performs a movement to enter the immediate vicinity of the terminal;
receiving a connection message comprising a password for said network;
pairing the terminal over said private network.

According to particular embodiments of the invention, the above methods are characterized in that:
Said connection message is transmitted or received over the near-field channel.

Advantageously, according to this embodiment, the connection message containing the password is transmitted over the IBC channel. It is only transmitted if the user is in the physical vicinity of the two items of equipment (access point and terminal), which offers an additional degree of security.
Said connection request message comprises at least one identification datum for the terminal.

Advantageously, according to this embodiment, the request message contains an identifier for the terminal, such as an address, a serial number, etc. This identifier facilitates the successive pairing of the terminal by the access point. If the terminal transmits, for example, its IP or MAC address to a gateway, it will be able to simply authorize or refuse the pairing, to record it in the list of terminals authorized to access the private network for a subsequent connection, etc.
Said connection message comprises the network name.

Advantageously, according to this embodiment, with the connection message containing the network name, the terminal is not obliged to carry out a discovery phase beforehand. In addition, the name remains secret if it is transmitted over the IBC channel, which has a security advantage.
Said request and/or connection message is transmitted or received during an ISO 14443 type communication.

Advantageously, according to this embodiment, an existing standard is reused and followed by all the NFC equipment on the market. During an ISO 14443-3 type communication, messages stipulated by the standard are exchanged between two devices (with one generally being in reader mode and the other being in card emulation mode). If the new request and/or connection message follows the message format of the NFC standard (in terms of frequency, coding modes, frame types, frame content, etc.), the compatibility with the pool of existing terminals and access points can be best assured.
The request for connecting to the private network is indicated in a field of the message that is left empty by the NFC standard for future use or for a proprietary application.
The password is indicated in a field of the message that is left empty by the NFC standard for future use or for a proprietary application.

Advantageously, according to these embodiments, the protocol and the format of frames of an existing NFC standard are reused by using a field that is left empty, or a field that is already defined for proprietary applications, in a frame, which therefore does not disrupt the operation of a receiver that would only be of the NFC type.
The step of transmitting the connection message is preceded by setting the near-field module of the access point to reader mode.
The step of obtaining the request message is preceded by setting the near-field module of the access point to card emulation mode.
The step of transmitting the request message is preceded by setting the near-field module of the terminal to reader mode.
The step of receiving the connection message is preceded by setting the near-field module of the terminal to card emulation mode.

The invention also relates to a device for pairing a terminal provided with a near-field module over a private network having an access point provided with a near-field module, with said access point being located in the immediate vicinity of a user, said device being characterized in that at the access point it is configured to:
communicate with the access point over a first near-field channel using the electromagnetic wave conduction capabilities of the body of said user, and over a second channel separate from the first channel;
obtain a request message for connecting over the first channel when said user performs a movement to enter the immediate vicinity of the terminal;
transmit a connection message comprising a password for said network;
pair the terminal over said network administered by the access point.

The invention also relates to a device for requesting pairing of a terminal provided with a near-field module over a private network having an access point provided with a near-field module, with said access point being located in the immediate vicinity of a user, characterized in that at the terminal it is configured to:
communicate with the access point over a first near-field channel using the electromagnetic wave conduction capabilities of the body of said user, and over a second channel separate from the first channel;
transmit a request message for connecting over the first channel when said user performs a movement to enter the immediate vicinity of the terminal;
receive a connection message comprising a password for said network;
pair the terminal over said private network.

The invention also relates to a computer program comprising instructions for implementing one of the methods according to any one of the particular embodiments described above, when said programs are executed by a processor. The methods can be implemented in various ways, notably in wired form or in software form.

These programs can use any programming language and can be in the form of source code, object code or of intermediate code between source code and object code, such as in a partially compiled format or in any other desirable format.

The invention also relates to a recording medium or to a computer-readable information medium, and comprising instructions of a computer program as mentioned above. The aforementioned information media can be any entity or device capable of storing the program. For example, the medium can comprise a storage means, such as a ROM, for example, a CD-ROM or a microelectronic circuit ROM, or even a magnetic recording means, for example, a hard disk. Moreover, the information media can be a transmissible medium such as an electrical or optical signal, which can be routed via an electrical or optical cable, via a radio or via other means. The programs according to the invention particularly can be downloaded over a network of the Internet type.

Alternatively, the information media can correspond to an integrated circuit, in which the program is incorporated, with the circuit being adapted to execute or to be used to execute the methods in question.

### 4. LIST OF FIGURES

Further features and advantages of the invention will become more clearly apparent upon reading the following description of particular embodiments, which are provided by way of simple illustrative and non-limiting examples, and with reference to the appended drawings, in which:

FIG. 1 illustrates an example of an environment for implementing the invention according to a particular embodiment of the invention;

FIG. 2 illustrates an example of an environment for implementing the invention according to another particular embodiment of the invention;

FIG. 3 shows steps of the pairing method over a private network according to a particular embodiment of the invention;

FIG. 4 shows the architecture of an access point according to a particular embodiment of the invention;

FIG. 5 shows the architecture of a terminal according to a particular embodiment of the invention;

FIG. 6 illustrates an NFC/IBC request frame according to a particular embodiment of the invention

### 5. DESCRIPTION OF AN EMBODIMENT OF THE INVENTION

The general principle of the invention is to create a secure private communication network between at least two terminals. This private network can be a subset of an already existing local area network (for example, that of the home, administered by the service gateway) or a new private network (for example, a guest network of such a gateway).

FIG. 1 illustrates an example of an environment for implementing the invention according to a particular embodiment.

According to this embodiment, the mobile device DM is positioned at the access point (this technique is also called connection sharing mode, or “tethering” or hotspot) and authorizes the connection of one or more terminals (PC1 and/or PC2) to the access point via a near-field initialization of the Intra Body Communication (IBC) type. Subsequently, the terminals of the private network thus created can communicate and optionally can communicate with other terminals on another network (Internet, etc.) via the access point.

The mobile device DM according to the invention is a portable device inherently capable of receiving radio carrier waves, via an antenna, through the body of the user U. To this end, the mobile device DM is located in the immediate vicinity of the user U, without necessarily being in direct contact with them. For example, the mobile device DM is placed inside a pocket or a bag carried against the user. In these configurations, the mobile device DM is considered to be no more than a few centimeters away from the body of the user. The distance is less than 5 cm, for example. According to this example, this is a mobile device provided with an NFC antenna (not shown) adapted in IBC mode to receive the modulated electrical signals in the form of an electromagnetic wave through the body of the user when the user is in the immediate vicinity of the terminal PC1. A terminal is a device with a Wi-Fi connection and an NFC/IBC module, such as a laptop computer, a tablet, a connected object (printer, hard disk, decoder, smartphone, etc.).

According to the particular embodiment illustrated in FIG. 1, data is transmitted between the terminal PC1 and the mobile device DM of the user via the IBC channel. This data corresponds to connection data allowing the mobile device DM to authorize the terminal PC1 over a private local area network administered by the access point of the mobile device.

When the user touches the terminal PC1 with their hand, for example, the NFC signal transmitted by the terminal PC1 is transmitted via the body of the user to their mobile device DM.

To this end, according to one example, the terminal PC1 is set to reader mode according to the NFC standard and then encodes a near-field communication NFC protocol frame, for example, a B-type frame according to the ISO/CEI 14443-3 protocol. FIG. 6 illustrates an example of a portion of such a frame. To this end, the terminal PC1 generates an NFC frame comprising a connection request indicating the request to connect to the private network, for example, as will be described hereafter, in an “AFI” field (identifier of the family of applications) of the NFC frame. Optionally, the NFC frame comprises an identifier for the terminal PC1 (ID_PC1) allowing the mobile device DM to recognize it and/or register it before establishing a Wi-Fi communication with the terminal PC1 in order to send it the access codes to its private network.

The mobile device DM receives the NFC/IBC signal transmitted by the terminal PC1 (transmitted via the body of the user), decodes the received NFC/IBC frame, extracts the connection request therefrom and optionally a datum relating to the terminal PC1, according to one example, the MAC address or the IP address of the terminal PC1.

The mobile device DM then pairs the terminal PC1 over its Wi-Fi hotspot network, i.e., it transmits the password of the Wi-Fi hotspot network. Optionally, it also transmits a network name. In a known manner, in a Wi-Fi network of the “hotspot” type, the access point and a terminal share a secret. This is, according to the IEEE 802.11 standard, a PSK (Pre-Shared Key) shared security key, which is human readable and includes between 8 and 63 characters in the ASCII format. The PSK key is generally selected by the application of the mobile device and any terminal wishing to connect thereto must know this key. According to the prior art, the user of the terminal PC1 must enter this key via an interface on the terminal so that said terminal can establish a connection with the access equipment DM. The method according to the invention dispenses with this: the pairing, initiated via the IBC, prevents the user from entering the network identifiers. It also allows the hotspot network of the mobile device to be secured: only the terminals approached (in terms of NFC proximity) by the user are authorized to connect to the hotspot.

According to one embodiment, the network identifiers are transmitted to the terminal by Wi-Fi.

According to another embodiment, the network identifiers are transmitted by Bluetooth.

According to another embodiment, the network identifiers are transmitted in an NFC/IBC frame transmitted by the mobile device DM. It is set to reader mode according to the NFC standard and then: according to a first alternative embodiment, the user approaches their mobile device DM toward the terminal PC1 in order to conventionally send it an NFC frame comprising the network identifiers; according to a second alternative embodiment, the user keeps their mobile device in a pocket and the frame is transmitted in the IBC format. In this case, the terminal PC needs to be set to “card emulation” mode according to the NFC standard and be capable of receiving IBC frames, which assumes that its reception power is appropriate for the NFC-IBC waves.

Once the terminal PC1 has the hotspot network identifiers, it conventionally connects thereto by Wi-Fi. The terminal PC2 can pair with the hotspot of the mobile device DM in the same way.

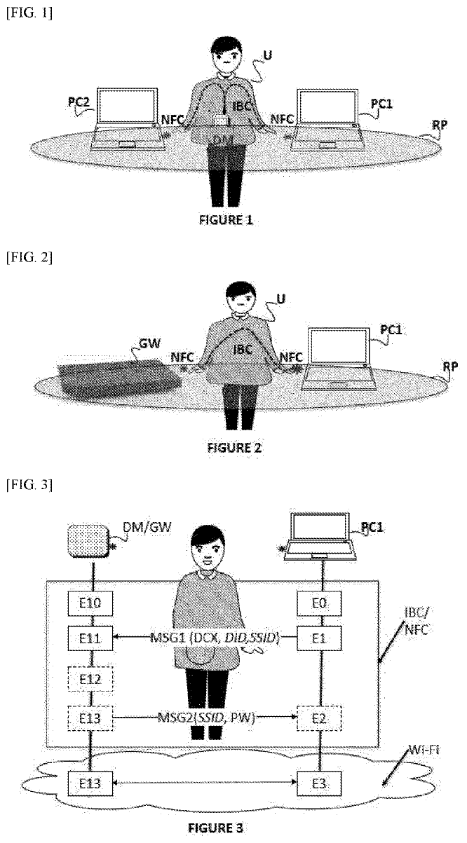

FIG. 2 illustrates an example of an environment for implementing the invention according to a particular embodiment of the invention.

According to this embodiment, the local area network gateway of the user GW authorizes the connection of the terminal PC1 to a private network via a near-field initialization of the Intra Body Communication (IBC) type. This private network can be the local area network conventionally administered by the gateway, or a subset of this local area network, or another local area network that the gateway can define as a private “guest network”, for example, concerning only the terminals that are “touched” by the user (in terms of NFC proximity) and are intended, for example, to share sensitive information.

The user stands close to or touches the gateway provided with an NFC/IBC module according to the invention. They then simply need to also touch a terminal provided with a corresponding module (for example, by holding a portable PC or a tablet) for the terminal to be paired over a local area network of the access point of the gateway.

According to the prior art, to access a local area network, a user must connect to the service gateway from the terminal. To connect to the gateway, the user enters the identification parameters of the local area network into the terminal, for example, of the Wi-Fi type. In particular, using a preliminary process called “pairing”, which is well known to a person skilled in the art, they enter or select the name of the local area network, known by the abbreviation SSID (“Service Set Identifier”), which often assumes the form of an alphanumeric string (for example: “Livebox_666”) and, in most cases, a key, or password, for accessing the home network, such as a WEP (“Wired Equivalent Privacy”) or WPA (“Wi-Fi Protected Access”) key. The definition of a security key of a Wi-Fi network requires the generation of relatively long alphanumeric security keys, due to the compromise to be made between the security of the network and the ease of storing and/or sharing the key. The WEP key generated to protect access to the local area network of the user can be in the known form of a series of 26 hexadecimal characters (for example, “32F34DA4CFE9EAD355A49EAE17”). The user is often reluctant to use such long and complex keys. According to this embodiment of the invention, data is transmitted between the terminal PC1 and the service gateway via the IBC channel. This data allows the gateway to authorize the terminal PC1 over its private network (main or “guest”).

When the user touches the terminal PC1 with their hand, for example, the NFC signal transmitted by the terminal PC1 is transmitted via the body of the user to the gateway. To this end, the terminal PC1 encodes, for example, as described above, a near-field communication NFC protocol frame, after being set to reader mode according to the NFC standard. This message can include a connection request and/or an identifier of the terminal PC1 (IP address or MAC address).

The gateway receives the NFC signal transmitted by the terminal PC1 (transmitted via the body of the user), decodes the received NFC frame, extracts the connection request therefrom and optionally an identifier of the terminal PC1. In this case, the gateway must be able to receive IBC frames, which assumes that its reception power is appropriate for the NFC-IBC waves.

The gateway transmits the password and optionally the name of the local area network.

According to one embodiment, the network identifiers are transmitted to the terminal by Wi-Fi.

According to another embodiment, the network identifiers are transmitted by Bluetooth.

According to another embodiment, the network identifiers are transmitted in an NFC/IBC frame transmitted by the gateway. It is set to reader mode according to the NFC standard and then: according to a first alternative embodiment, the user approaches their gateway in order to conventionally send it an NFC frame comprising the network identifiers; according to a second alternative embodiment, the user keeps their terminal at a distance from the gateway and the frame is transmitted in the IBC format. In this case, the terminal PC needs to be able to receive IBC frames, which assumes that its reception power is appropriate for the NFC-IBC waves.

Once the terminal PC has the identifiers of the local area network (SSID and WEP key), it is conventionally connected thereto.

The gateway then proceeds to pair the terminal PC1 over its private network, i.e., it authorizes it on the private network defined by the name and the password (main or guest network).

FIG. 3 shows steps of the method for creating a private network according to a particular embodiment of the invention as described with reference to FIG. 1 or 2. Hereafter, the mobile device DM and/or the gateway GW are called “access point” PA.

At the end of the method, at least one terminal PC is paired over the private network of the access point. Pairing, which is carried out via IBC, allows the network in question to be secured: the fact that the user “touches” the terminal is actually a security guarantee.

During a step EO, the terminal PC prepares for the connection. It turns on (or the user does so on its behalf) a Wi-Fi type radio channel and, if applicable, the NFC/IBC module, if it is not activated by default. It preferably sets itself to card reader mode in order to be able to transmit frames in accordance with the NFC standards.

During a step E10, the access point is prepared for the connection. If applicable, it turns on (or the user does so on its behalf) a Wi-Fi type radio channel, and sets itself to Wi-Fi “hotspot” mode. If applicable, it activates the NFC/IBC module, if it is not activated by default. It preferably sets itself to “card emulation” mode in order to be able to receive frames in accordance with the NFC standards.

During a step E1, the terminal prepares and then transmits an NFC signal adapted for transmission via the human body, advantageously of the NFC type (i.e., at the NFC frequency—13.56 MHz and with the features of the NFC standard). This signal includes an NFC type request message, with the aim of initiating a dialogue between the terminal and the access point, in NFC/IBC mode, in accordance with the NFC standards.

The body of the user receives the wave and transforms into an antenna, i.e., it re-emits the electromagnetic wave that is thus scattered throughout their body.

A datum DCX requesting connection to the service is introduced into the signal. It can be, for example, a service code corresponding to a request to connect to the private network of the access point. The new message MSG1 preferably complies with the message format of the standard. According to one example, described hereafter with reference to FIG. 6, this is an NFC-B type message, and therefore the fields are reused to good effect to indicate the required type of communication (connection request to the local area network via IBC) and optionally data from the terminal and/or, in a non-exhaustive manner, any data useful for pairing, such as the private network name if already known by the terminal.

According to one embodiment, a personal datum DID relating to the terminal (address, unique identifier, etc.) is introduced into the signal. It can be, for example, a number, a reference, a key, etc., or, more generally, any identification sign that subsequently allows the access point to accept and optionally to store this device. It can be, for example, a number, a reference, a key, etc., or, more generally, any identification sign that subsequently allows the access point to accept this terminal (for example, the MAC address of the terminal).

According to one embodiment, the network name (for example, SSID) is introduced into the signal. This assumes that the terminal knows the name, either because the mobile device is set as a hotspot and therefore broadcasts its name over a Wi-Fi channel, or because the terminal has stored the name during a previous connection.

According to an alternative embodiment, a set of known names of the terminal is introduced into the signal (for example, a list of SSIDs).

During a step E11, the access point receives the signal originating from the body of the user; to this end, the access point is set (for example, by the application) to a mode for receiving the electromagnetic wave. The access point receives and demodulates the received signal. If the signal includes a connection request datum DCX, the method continues with a step E12.

During the optional step E12, a personal datum DID relating to the terminal (address, unique identifier, etc.) is read in the signal. The access point stores this identifier, for example, in a table in the memory M, for subsequent use. It also optionally reads the network name if it is transmitted in the signal.

During a step E13, the mobile device DM prepares a message MSG2 including the network password PW and optionally the network name (if it is not received during the preceding step). According to this embodiment, this message MSG2 is transmitted in a signal through the body of the user; to this end, the access point is set to a reader mode. According to another embodiment, this message is transmitted over a Wi-Fi, Bluetooth channel, etc.

During a step E2, the terminal receives the message, which according to this embodiment is broadcast through the body of the user. It extracts the password therefrom and optionally the network name (if it is not known and transmitted in the previous step).

A communication channel then can be conventionally established between the terminal and the access point, during steps E3 and E13: the terminal sends, for example, the access point the name and the password, and the access point accepts the connection if the name and the password are correct. From this instant, the terminal is connected to the private network of the access point.

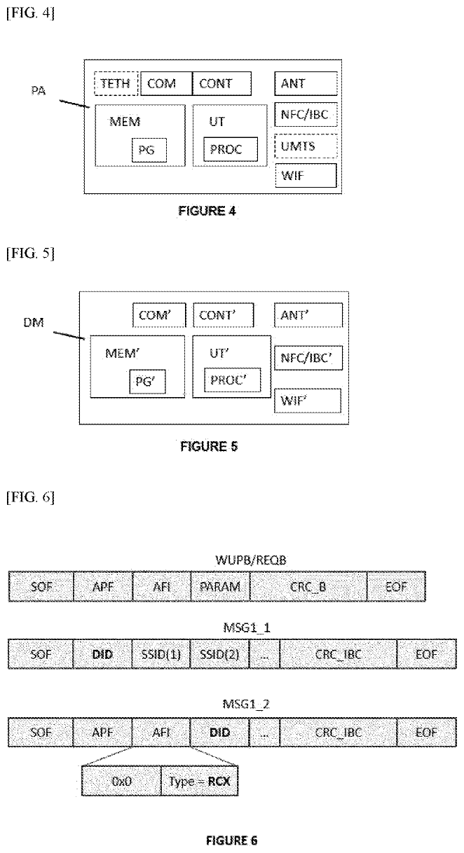

FIG. 4 shows the architecture of an access point PA according to particular embodiments of the invention. By way of a reminder, the access point PA can be a mobile device DM set as a hotspot (FIG. 1), or a service gateway GW of a local area network (FIG. 2).

According to a particular embodiment of the invention, the access point PA has the conventional architecture of a computer and notably comprises a memory MEM, a processing unit UT, provided with a processor PROC, for example, and controlled by the computer program PG stored in the memory MEM. The computer program PG comprises instructions for implementing the steps of the pairing method as described above, according to any one of the embodiments thereof, when the program is executed by the processor.

Upon initialization, the code instructions of the computer program PG are loaded, for example, into a memory before being executed by the processor.

A mobile device DM further comprises an access point or tethering TETH mode, that allows it to convert into a gateway.

The access point PA further comprises a set of modules COM (routing modules, etc.) that conventionally allow it to communicate with one or more terminals of its local area network and grant them access to a LAN or a WAN (mobile network, Internet, etc.).

The access point PA also comprises a certain number of modules that allow it to communicate with the local and wide area networks, via various protocols over various physical links. FIG. 4 thus schematically shows a Wi-Fi module WIF allowing wireless communications with the Internet network, the mobile network, and/or the local area network. It also can be a Bluetooth, Li-Fi, Ethernet module, etc.

The access point, the mobile device or the gateway also comprise an application module CONT responsible for controlling the IBC/Wi-Fi communication according to some embodiments of the invention. The module CONT, which can be software and/or hardware, is notably able to carry out the actions that have been described with reference to the preceding figures: setting the access point to the IBC mode for transmission and/or reception, to reader or NFC card emulation mode, retrieving and storing the message MSG1 including the connection request and the identification of the terminal, preparing and transmitting the connection identifiers MSG2, actual connection with the terminal, etc.

A portion of the memory MEM stores, among other things, the identification and association parameters of the home terminals at the access point (table of identifiers including the unique identifiers of the domestic terminals that have already been authorized to access the home network via the access point, routing elements, etc.).

The device PA also comprises an NFC/IBC communication module configured to establish contactless communications, and in particular to transmit a signal intended to be transmitted by the body of the user, and in response to receive an electromagnetic signal that has passed through and has been retransmitted by the body. This module conventionally comprises an NFC antenna ANT adapted to receive signals over the radio channel and via the body of the user, so that a modulated electrical signal conveyed by the body of the user is able to be received by the NFC antenna when it is in the vicinity of the human body. The term “adapted” is understood to mean that the antenna can be amplified, or that the antenna has high enough gain. Acquiring such an antenna or amplifying it is within the abilities of a person skilled in the art. The NFC/IBC module also comprises a demodulator (not shown), intended to receive a modulated electrical signal via the antenna and to convert it into a digital signal intended to be transmitted to the processing unit, a modulator, a controller and software components (firmware, etc.) required for implementing NFC/IBC communications.

It also optionally comprises a Bluetooth type communication module. It also optionally comprises a UMTS type communication module or the like for accessing the mobile network.

All the modules conventionally communicate with one another via a data bus (not shown).

FIG. 5 shows the architecture of a terminal according to particular embodiments of the invention.

The terminal PC has the conventional architecture of a computer and notably comprises a memory MEM′, a processing unit UT′, equipped, for example, with a processor PROC′, and controlled by the computer program PG′ stored in the memory MEM′. The computer program PG′ comprises instructions for implementing the steps of the pairing request method as described above, according to any one of its embodiments, when the program is executed by the processor.

Upon initialization, the code instructions of the computer program PG′ are loaded, for example, into a memory before being executed by the processor.

It further comprises a module COM′ for communicating with an access point, as well as a certain number of modules that allow it to communicate via various protocols over various physical links. FIG. 5 thus schematically shows a Wi-Fi module WIF′ allowing wireless communications with the access point. It also can be a Bluetooth, Li-Fi, Ethernet module, etc.

The terminal also includes an application module CONT′ responsible for controlling the IBC/Wi-Fi communication according to some embodiments of the invention. The module CONT′, which can be software and/or hardware, is notably able to carry out the actions that have been described with reference to the preceding figures: setting the terminal to the IBC mode for transmission and/or reception, to reader or NFC card emulation mode, preparing and transmitting the message MSG1 including the connection request and the identification of the terminal, receiving the connection identifiers MSG2, actual connection with the access point, etc.

The terminal PC also comprises an NFC/IBC′ communication module configured to establish contactless communications, and in particular to transmit a signal intended to be transmitted by the body of the user, and in response to receive an electromagnetic signal that has passed through and has been retransmitted by the body.

This module conventionally comprises an NFC antenna ANT′ adapted to receive signals over the radio channel and via the human body, so that a modulated electrical signal conveyed by the body is able to be received by the NFC antenna when it is in the vicinity of the body of the user. The term “adapted” is understood to mean that the antenna can be amplified, or that the antenna has high enough gain. Acquiring such an antenna or amplifying it is within the abilities of a person skilled in the art. The NFC/IBC′ module also comprises a demodulator (not shown), intended to receive a modulated electrical signal via the antenna and to convert it into a digital signal intended to be transmitted to the processing unit, a modulator, a controller and software components (firmware, etc.) required for implementing NFC/IBC communications.

All the modules conventionally communicate with each other via a data bus (not shown).

FIG. 6 illustrates an NFC/IBC request frame according to a particular embodiment of the invention.

By way of a reminder, NFC communications can cover two types of applications linked to two different operating modes on an NFC device:
the first mode, called reader mode, relates to reading data on transponder type devices, or NFC cards. The device is active in this mode. It transmits commands as it would send them to a contactless card according to standard ISO 14443 (or FeliCa). It generates a magnetic field, which, in contact with the antenna of the passive card, induces an electric current that powers the card;
the second mode, called emulation mode, implements emulation of a near-field communication module, typically in order to secure electronic transactions between an application stored on the device and an external reader terminal; in this mode, the NFC equipment of the device is used passively. It simulates the behavior that a card would assume without passive contact. It is able to receive an initialization message from the reader.

The main steps of initializing the NFC communication between a transmitter and a card are defined in section 3 of the ISO 14443-3 standard. For a B-type card, the reader terminal sends an identification request (called “REQB” or “WUPB”) and waits for a response (called “ATQB”) from the mobile terminal. This embodiment proposes reusing such a protocol message, so as to introduce an indication of a request to connect to the network DCX in the request message MSG1 and optionally a certain amount of data for the subsequent communication (DID identifier for the terminal, SSID, etc.).

As illustrated in FIG. 6, and as described in the aforementioned standard 14443-3, the standardized REQB/WUPB message contains:
a frame start byte, SOF;
an anti-collision prefix byte APf (of fixed value, as 0x5 hexadecimal);
an “AFI” byte indicating the application family representing the type of application targeted by the NFC reader (all applications—code 00, transport, finance, telecommunication, etc.). Only proximity cards with applications of the type indicated by the AFI are authorized to respond to an REQB/WUPB command with an AFI other than “00”. When AFI is equal to “00”, all the proximity cards must process REQB/WUPB. These coding rules are specified in table 12 of the aforementioned 14443 standard, reproduced below;
a “param” byte notably indicating the type of request (REQB or WUPB);
a “CRC” byte over two bytes comprising a code for detecting and correcting the errors.

TABLE 12
AFI coding

| AFI | AFI | | |
|---|---|---|---|
| Most Significant | Least Significant half | Meaning - | |
| half byte | byte | PICCs respond from | Examples/Note |
| ‘0’ | ‘0’ | All families and sub-families | No application preselection |
| X | ‘0’ | All sub-families of family X | Wide application preselection |
| X | Y | Only the Yth sub-family of family X | |
| ‘0’ | Y | Proprietary sub-family Y only | |
| ‘1’ | ‘0’, Y | Transport | Mass transit, Bus, Airline, . . . |
| ‘2’ | ‘0’, Y | Financial | IEP, Banking, Retail, . . . |
| ‘3’ | ‘0’, Y | Identification | Access Control, . . . |
| ‘4’ | ‘0’, Y | Telecommunication | Public Telephony, GSM, . . . |
| ‘5’ | ‘0’, Y | Medical | |
| ‘6’ | ‘0’, Y | Multimedia | Internet services . . . |
| ‘7’ | ‘0’, Y | Gaming | |
| ‘8’ | ‘0’, Y | Data Storage | Portable Files, . . . |
| ‘9’-’F’ | ‘0’, Y | RFU | |

FIG. 6 illustrates a possible reuse of these fields, relating to a particular implementation mode.

The connection request message MSG1 contains, according to this example MSG1_1, the frame start message SOF immediately followed by the data bytes required for the IBC request. Since the AFI field is overwritten, the NFC module of the access point will not respond to this request. The data fields can notably include an identifier of the terminal (DID, for example, the MAC address of the terminal), the network name (distributed over two bytes according to the example), etc. The message also contains a “CRC_IBC” byte over two bytes including a code for detecting and correcting the errors.

The connection request message MSG1 contains, according to a second example MSG1_2:
a first non-modified anti-collision prefix byte APf; then
the “AFI” byte adapted for the IBC while maintaining compatibility with the standard. With reference to table 12 of the aforementioned standard 14443, reproduced above, the value 0x0 of the first half-byte corresponds to a private sub-family of the type specified in the second half-byte. This second half-byte therefore can be used to specify a type of IBC request (in this case, DCX, the request to connect to the local area network, for example, DCX=‘1’). It should be noted that it is possible, in this way, to provide several types of requests, notably varying according to the type of network: connection to a network of the Wi-Fi, Bluetooth, Ethernet, mobile type, etc.

Of course, these two examples are by no means limiting and a person skilled in the art could contemplate any adaptation of this message or of another NFC initialization message. For example:
the hexadecimal values 0x9 to 0xF of the first half-byte of the AFI field are reserved; it is therefore possible, without affecting the standard, to use one of these reserved values, for example, 0x9 for the IBC applications, in general, the second half-byte of the field comprising the type of IBC application;
a modification of the value of the field SOF would allow the mobile terminal to immediately detect a non-NFC message;
etc.

The connection message MSG2 can use a similar type of format for conveying the data transmitted from the access point to the terminal (password, SSID, etc.). To this end, the access point must be set to reader mode and the terminal to card emulation mode.

1. A method comprising:
pairing a terminal provided with a near-field module over a private network having an access point provided with a near-field module, with said access point being located in an immediate vicinity of a user, said access point being able to communicate with the terminal over a first near-field channel using electromagnetic wave conduction capabilities of the body of said user, the pairing comprising, at the access point:
obtaining a request message for connecting to the private network over the first near-field channel, when said user performs a movement to enter an immediate vicinity of the terminal;
transmitting a connection message comprising a password for said network; and
pairing the terminal over said private network.

2. A method comprising:
requesting pairing of a terminal provided with a near-field module over a private network having an access point provided with a near-field module, with said access point being located in an immediate vicinity of a user, said access point being able to communicate with the terminal over a first near-field channel using electromagnetic wave conduction capabilities of the body of said user the requesting comprising, at the terminal:
transmitting message over the first near-field channel requesting connection to the private network when said user performs a movement to enter an immediate vicinity of the terminal;
receiving a connection message comprising a password for said network; and
pairing the terminal over said private network.

3. The method as claimed in claim 1, wherein said connection message is transmitted over the first near-field channel.

4. The method as claimed in claim 1, wherein said connection request message comprises at least one identification datum for the terminal.

5. The method as claimed in claim 1, wherein said connection message comprises a network name.

6. The method as claimed in claim 1, wherein said request message is obtained or during an ISO 14443 type-communication.

7. The method as claimed in claim 6, wherein the request for connecting to the private network is indicated in a field of the message that is left empty by the Near Field Communication standard for future use or for a proprietary application.

8. The method as claimed in claim 3, wherein said connection message is transmitted during an ISO 14443 type communication.

9. The method as claimed in claim 8, wherein the password is indicated in a field of the message that is left empty by the NFC standard for future use or for a proprietary application.

10. An access point for pairing a terminal provided with a near-field module over a private network, the access point comprising:
a near-field module;
at least one processor; and
at least one non-transitory computer readable medium comprising instruction stored thereon which when executed by the at least one processor configure the access point to:
communicate with the terminal over a first near-field channel using electromagnetic wave conduction capabilities of the body of said user when the access point is located in an immediate vicinity of the user;
obtain a request message for connecting over the first near-field channel when said user performs a movement to enter an immediate vicinity of the terminal;
transmit a connection message comprising a password for said network; and
pair the terminal over said private network.

11. A terminal for requesting pairing of the terminal over a private network having an access point provided with a near-field module, with said access point being located in an immediate vicinity of a user, wherein the terminal comprises:
a near-field module;
at least one processor; and
at least one non-transitory computer readable medium comprising instruction stored thereon which when executed by the at least one processor configure the access point to:
communicate with the access point over a first near-field channel using electromagnetic wave conduction capabilities of the body of said user;
transmit a request message for connecting over the first near-field channel when said user performs a movement to enter an immediate vicinity of the terminal;
receive a connection message comprising a password for said network; and
pair the terminal over said private network.

12. A non-transitory computer readable medium comprising instructions stored thereon for implementing a method for pairing a terminal, when said instructions are executed by a processor of an access point provided with a near-field module, wherein the method comprises:
pairing the terminal, which is provided with a near-field module, over a private network having the access point, with said access point being located in an immediate vicinity of a user, said access point being able to communicate with the terminal over a first near-field channel using electromagnetic wave conduction capabilities of the body of said user, the pairing comprising, at the access point:
obtaining a request message for connecting to the private network over the first near-field channel, when said user performs a movement to enter an immediate vicinity of the terminal;
transmitting a connection message comprising a password for said network; and
pairing the terminal over said private network.

13. The method as claimed in claim 2 wherein said connection message is received over the first near-field channel.

14. The method as claimed in claim 2, wherein said connection request message comprises at least one identification datum for the terminal.

15. The method as claimed in claim 2, wherein said connection message comprises a network name.

16. The method as claimed in claim 2, wherein said request message is transmitted during an ISO 14443 communication.

17. The method as claimed in claim 16, wherein the request for connecting to the private network is indicated in a field of the message that is left empty by the Near Field Communication (NFC) standard for future use or for a proprietary application.

18. The method as claimed in claim 13, wherein said connection message is received during an ISO 14443 type communication.

19. The method as claimed in claim 18, wherein the password is indicated in a field of the message that is left empty by the NFC standard for future use or for a proprietary application.
